(19) United States
(12) Patent Application Publication
(10) Pub. No.: US 2004/0232184 A1
(43) Pub. Date: Nov. 25, 2004

(54) Vehicle tow accessory for wheeled receptacle

(76) Inventors: Russel J. Moen, Roseville, CA (US); Wendy A. Moen, Roseville, CA (US)

Correspondence Address: Dawn Capp, Esq., The Bones Law Firm, 4790 Dewey Drive, Fair Oaks, CA, 95628, US

(21) Appl. No.: 10/845,807

(22) Filed: May 14, 2004

Related U.S. Application Data
(60) Provisional application No. 60/471,889, filed on May 19, 2003.

(51) Int. Cl. B60F 1/00; B60R 9/00; B60R 11/00

(52) U.S. Cl. 224/510; 224/521

(57) ABSTRACT

RECEPTACLE for use with a vehicle equipped with a vehicle receiver. The vehicle tow accessory attaches to a vehicle receiver and facilitates the transport of trash receptacles along driveways or small roads. The invention comprises separate parts that allow for adjustments to accommodate trash receptacles of various sizes. In the preferred embodiment of the invention, a trash receptacle tilts back to lean on a platform of the invention and is secured via chains or tethers.

### CROSS-REFERENCE TO RELATED APPLICATIONS

This application claims the benefit of Provisional Patent Application Ser. No. 60/471,889 filed 2003 May 19.

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to vehicle towing apparatuses, specifically those apparatuses designed to attach to wheeled trash receptacles to transport such wheeled trash receptacles.

2. Description of the Related Art

A variety of transport devices for trash receptacles have been marketed. For instance, wheeled carts have been made that attach to vehicles in various ways to allow the transport of different types of trash receptacles. However, these devices are bulky, heavy, and expensive. Many of the aforementioned devices allow trash receptacles to be lifted and transported.

The aforementioned devices have proved to be difficult to install, remove, and use. In addition, the aforementioned devices have primarily been designed to hold larger quantities of trash or large trash receptacles and most are designed for heavy commercial use. The need has therefore arisen for a compact, lightweight, and sturdy device that allows persons to transport small to medium-sized trash receptacles along driveways through the use of a device that allows the aforementioned trash receptacles to be secured to vehicles via hitches and common vehicle receivers.

### BRIEF SUMMARY OF THE INVENTION

The present invention is an apparatus for transporting a wheeled receptacle, such as a trash receptacle, along a driveway or small road via attachment to a vehicle hitch receiver, which will be hereafter referred to as a ‘vehicle receiver’ for the sake of convenience. The apparatus comprises an adjustable plate and a hitch, and a means for adjusting the size of the apparatus to allow it to accommodate wheeled receptacles of various sizes and also to accommodate vehicles of different sizes.

### OBJECTS AND ADVANTAGES

Accordingly, several objects and advantages of the invention are that it allows persons to transport wheeled receptacles along lengthy driveways quickly and easily. The invention will prove particularly useful for those who live in rural areas and those with mobility-related disabilities.

### BRIEF DESCRIPTION OF THE SEVERAL VIEWS OF THE DRAWINGS

FIG. 1 is a perspective view of the hitch.

FIG. 2 is a side view of the hitch.

FIG. 3 is rear perspective view of the adjustable plate.

FIG. 4 is a side perspective view of the adjustable plate.

FIG. 5 is a side view of the adjustable plate.

FIG. 6 is a rear view of the adjustable plate.

FIG. 7 is a perspective view of the pin.

FIG. 8 is a side view of the assembled invention showing the adjustable plate held in place inside the perpendicular sleeve of the hitch by the pin and secured to a vehicle receiver.

FIG. 9 is a side view of the assembled invention showing the adjustable plate held in place inside the perpendicular sleeve of the hitch by the pin.

FIG. 10 is a side view of the assembled invention showing the adjustable plate held in place inside the perpendicular sleeve of the hitch by the pin and showing how the invention attaches to a vehicle receiver.

### DETAILED DESCRIPTION OF THE INVENTION

The present invention solves the problem of the aforementioned devices because it provides a lightweight, compact, adjustable, and portable frame that attaches easily to an ordinary vehicle receiver. The present invention does not lift said trash receptacles and, instead, allows said trash receptacles to be transported along a driveway simply by being tilted back and secured by one or more chains or other tethers. The present invention is therefore designed to function with wheeled receptacles.

The present invention comprises an adjustable plate and a hitch. Said adjustable plate is separate and distinct from the hitch and furthermore comprises a platform and a vertical limb perpendicular to the platform. The hitch comprises a perpendicular sleeve that accommodates the vertical limb of the adjustable plate. Both said vertical limb and said perpendicular sleeve comprise a plurality of holes. In the preferred embodiment, the vertical limb can be positioned within said perpendicular sleeve and held at a fixed point by a pin that inserts into corresponding holes on both said vertical limb and said perpendicular sleeve, and this preferred embodiment therefore allows the height of said platform to be adjusted.

The present invention furthermore comprises a method for adjusting the apparatus horizontally to accommodate rear-mounted spare tires.

The present invention can be made of any solid material, but in the preferred embodiment, the invention should be made of a lightweight metal.

### DETAILED DESCRIPTION OF THE DRAWINGS

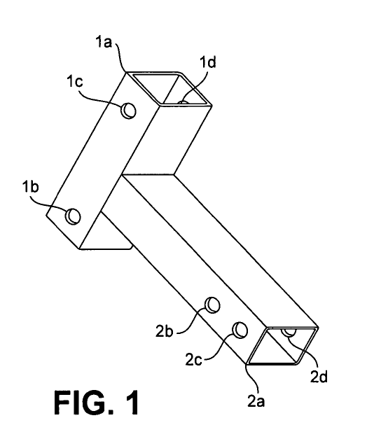

Referring now to the drawings wherein the showings are for purposes of illustrating preferred embodiments of the present invention only and not for purposes of limiting the same. FIG. 1 is a perspective view of the hitch. Perpendicular sleeve 1a is attached to horizontal arm 2a, forming a “T” shape. A plurality of holes 1b-1d are set in said perpendicular sleeve 1a and a plurality of holes 2b-2d are set in said horizontal arm 2a. Said holes 1b-1d and 2b-2d allow for adjustments in positioning when the apparatus is attached to a vehicle receiver and used to transport a wheeled receptacle.

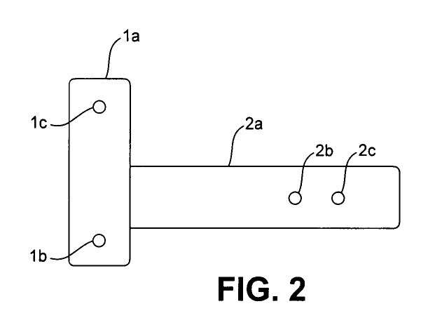

FIG. 2 represents a side view of the hitch, showing perpendicular sleeve 1a and holes 1b-1c as well as horizontal arm 2a and holes 2b-2c.

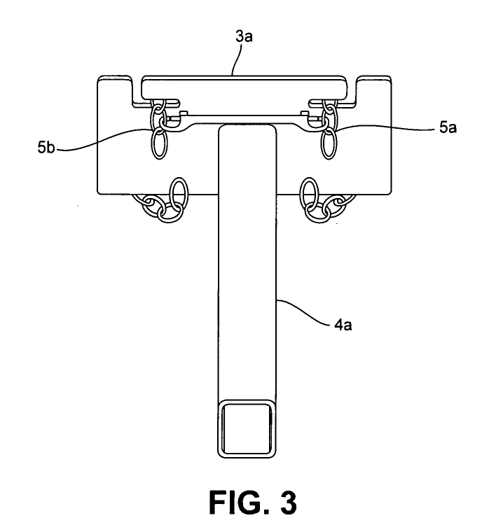

FIG. 3 is a rear perspective view of the adjustable plate showing the platform 3a and the vertical limb 4a. Chains or other suitable tethers 5a-b are attached to the platform and allow the wheeled receptacle to be secured to the platform.

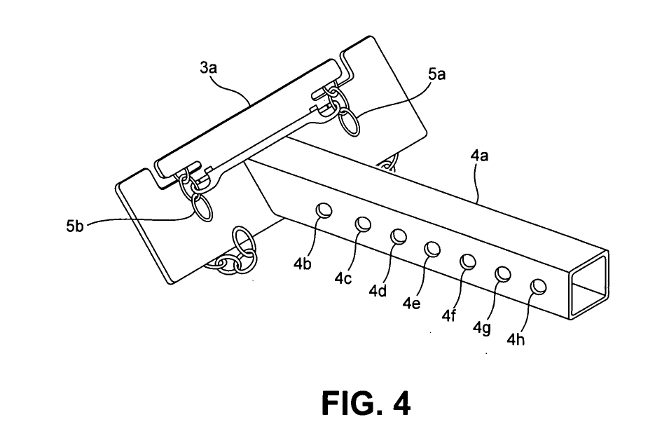

FIG. 4 is a side perspective view of the adjustable plate showing the platform 3a, the chains or tethers 5a-5b, the vertical limb 4a and holes 4b-4h.

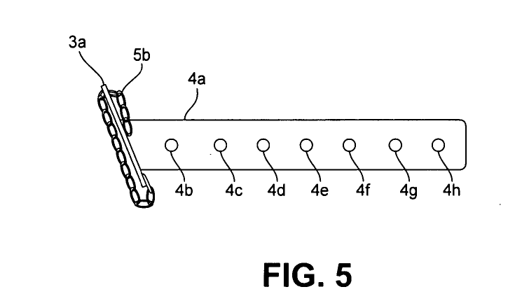

FIG. 5 is a side view of the adjustable plate showing the platform 3a, one chain 5b, the vertical limb 4a and holes 4b-4h.

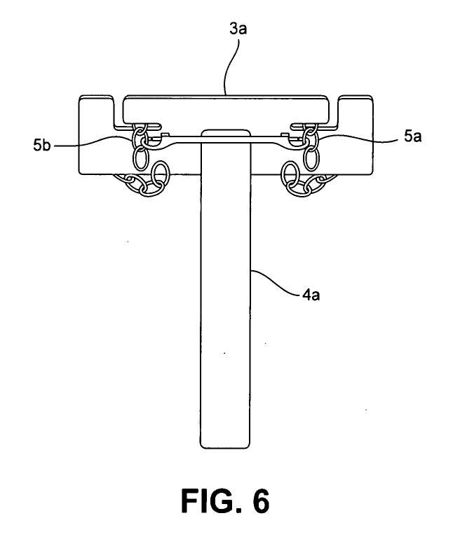

FIG. 6 is a rear view of the adjustable plate showing the platform 3a, the chains or other tethers 5a-5b, and the vertical limb 4a.

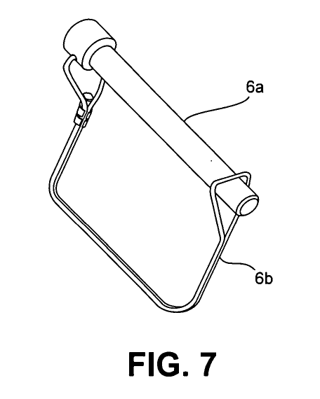

FIG. 7 shows the pin. The pin bar 6a slides through said holes on the perpendicular sleeve of the hitch and the vertical limb of the adjustable plate. Flexible member 6b serves to hold the pin bar 6a firmly in place.

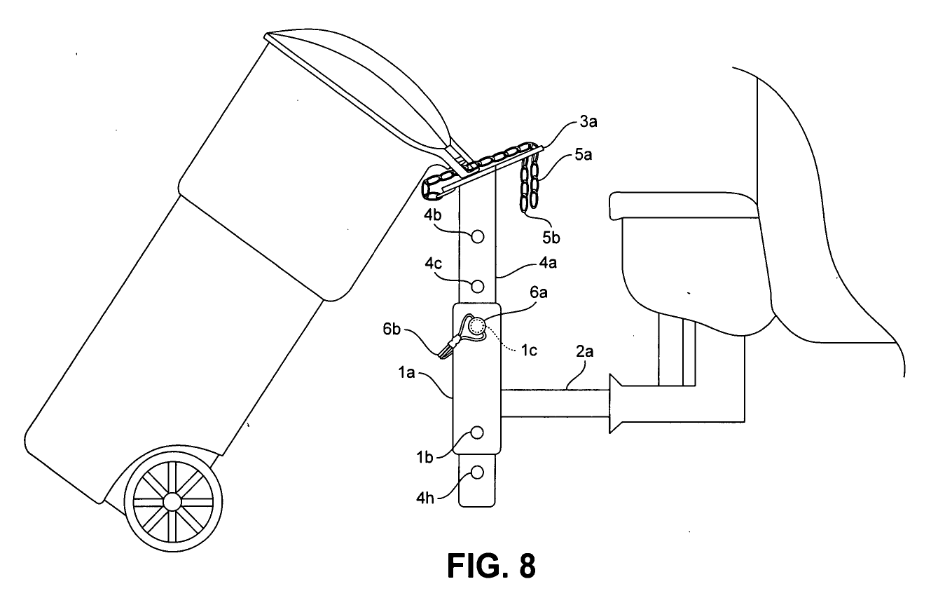

FIG. 8 shows the present invention fully assembled and attached to a vehicle receiver. Horizontal arm 2a of the hitch attaches to the vehicle receiver. Perpendicular sleeve 1a of the hitch is attached to the vertical limb 4a of the adjustable plate in such a way that the vertical limb may slide up and down to the desired position and then be fixed in such a position by the pin. The pin is shown set into hole 1c of the perpendicular sleeve. Holes 4b-4c and 4h are visible on the vertical limb. Hole 4d on the vertical limb is not visible but the drawing necessarily implies the pin bar going through hole 4d on the vertical limb. Flexible member 6b of the pin bar is shown holding the pin in place. The trash receptacle is shown leaning against the platform 3a of the adjustable plate and held securely by said chains or other suitable tethers 5a and 5b.

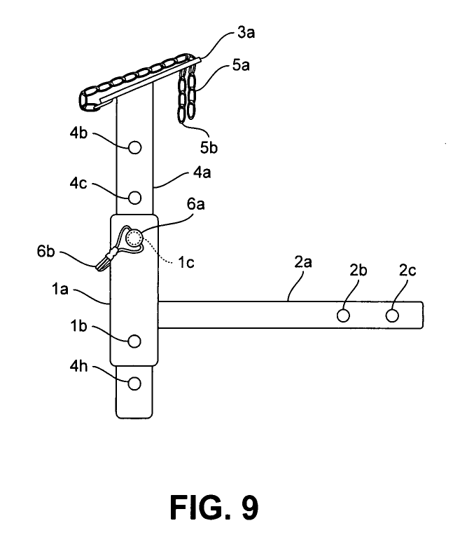

FIG. 9 shows the present invention assembled but unattached to a vehicle receiver or trash receptacle. Horizontal arm 2a of the hitch attaches to the vehicle receiver. Said perpendicular sleeve 1a of the hitch is adjustably attached to the vertical limb 4a of the adjustable plate. The pin is shown set into hole 1c of the perpendicular sleeve. Holes 4b-4c and 4h are visible on the vertical limb. Hole 4d on the vertical limb is not visible but the drawing necessarily implies the pin bar going through hole 4d on the vertical limb. Flexible member 6b of the pin bar is shown holding the pin in place. Platform 3a of the adjustable plate is shown, as are chains or tethers 5a-5b.

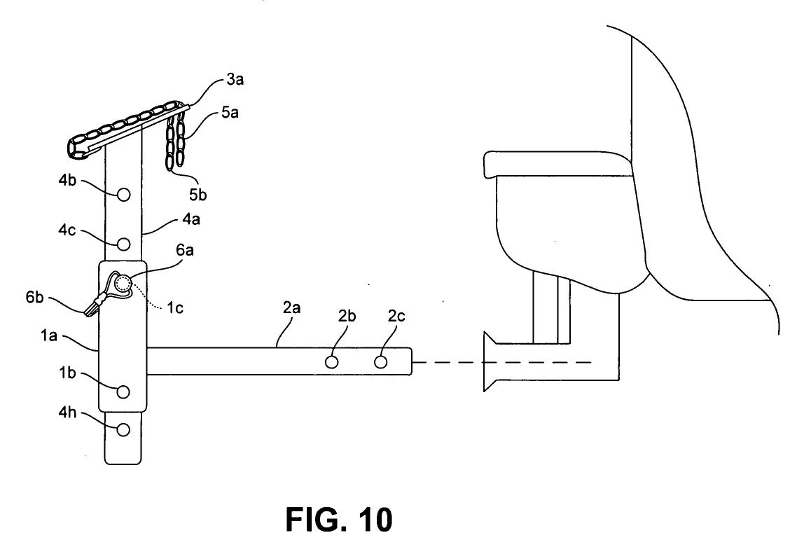

FIG. 10 shows the present invention fully assembled and about to be attached to a vehicle receiver. Horizontal arm 2a of the hitch attaches to the vehicle receiver. Perpendicular sleeve 1a of the hitch is adjustably attached to the vertical limb 4a of the adjustable plate. The pin bar 6a is shown set into hole 1c of the perpendicular sleeve. Holes 4b-4c and 4h are visible on the vertical limb. Hole 4d on the vertical limb is not visible but the drawing necessarily implies the pin bar going through hole 4d on the vertical limb. Flexible member 6b of the pin bar is shown holding the pin in place. Platform 3a of the adjustable plate is shown, as are the chains or tethers 5a-5b.

We claim:

1. An apparatus capable of being attached to a vehicle for transporting a trash receptacle or other wheeled container, the vehicle containing a vehicle receiver, said apparatus comprising:
an adjustable plate and a hitch, and
said adjustable plate comprising a platform and a vertical limb; and
said vertical limb comprising a plurality of holes; and
said hitch comprising a perpendicular sleeve and a horizontal arm.

2. The apparatus according to claim 1 wherein said adjustable plate and said hitch attach at a substantially right angle to one another.

3. The apparatus according to claim 1 wherein said perpendicular sleeve comprises a plurality of holes and accommodates said vertical limb for selectively adjusting said adjustable plate so that said adjustable plate can accommodate trash receptacles of various heights.

4. The apparatus according to claim 1 wherein said horizontal arm comprises a plurality of holes for adjustable attachment to a vehicle receiver.

5. An apparatus as in claim 1 wherein said platform comprises a means to secure a wheeled receptacle to the platform.

6. An apparatus as in claim 1 wherein said vertical limb of said adjustable plate slides into said perpendicular sleeve of said hitch.

7. A pin comprising a pin bar and a flexible member; and
said flexible member comprising a loop or hook to attach to the end of the pin bar.

8. An apparatus capable of being attached to a vehicle for transporting a trash receptacle or other wheeled container, the vehicle containing a vehicle receiver, said apparatus comprising:
an adjustable plate and a hitch, and
said adjustable plate comprising a platform and a vertical limb; and
said platform furthermore comprising a plurality of chains or other tethers; and
said platform furthermore comprising a plurality of L-shaped cut outs suitable to hold said chains or other tethers in place.
said vertical limb comprising a plurality of holes; and
said hitch comprising a perpendicular sleeve and a horizontal arm.
